(19) United States
(12) Patent Application Publication
(10) Pub. No.: US 2023/0328633 A1
(43) Pub. Date: Oct. 12, 2023

(54) Selective Providing of a Personalized Selective Service Set Identifier

(71) Applicant: ARRIS Enterprises LLC, Suwanee, GA (US)

(72) Inventors: Saravanan Mohandass, Bengaluru (IN); Siva Lingaprasad Sola, Bangalore (IN); Chilam Ng, Sunnyvale, CA (US)

(73) Assignee: ARRIS Enterprises LLC, Suwanee, GA (US)

(21) Appl. No.: 18/132,474

(22) Filed: Apr. 10, 2023

Related U.S. Application Data
(60) Provisional application No. 63/329,596, filed on Apr. 11, 2022.

(51) Int. Cl. H04W 48/14; H04W 48/10

(52) U.S. Cl. CPC H04W 48/14; H04W 48/10; H04W 84/12

(57) ABSTRACT

An access point that selectively provides an identifier of a WLAN is described. This access point may include an interface circuit that communicates with an electronic device and a second electronic device. During operation, the access point may receive, associated with the electronic device, information specifying the second electronic device and optionally the identifier of the WLAN. When the access point detects a presence of the second electronic device in proximity to the access point, the access point may selectively provide the identifier of the WLAN. Alternatively, when the access point does not detect the presence of the second electronic device in proximity to the access point within a time interval, the access point may selectively disable the identifier of the WLAN. Note that the identifier of the WLAN may include an SSID of the WLAN. For example, the SSID may include a personalized SSID of the second electronic device.

### CROSS REFERENCE TO RELATED APPLICATIONS

This application claims priority under 35 U.S.C. 119(e) to U.S. Provisional Application Ser. No. 63/329,596, “Selective Providing of a Personalized Selective Service Set Identifier,” filed on Apr. 11, 2022, by Saravanan Mohandass, et al., the contents of which are herein incorporated by reference.

### FIELD

The described embodiments relate to techniques for selectively providing an identifier of a wireless local area network (WLAN), such as a personalized selective service set identifier (SSID).

### BACKGROUND

Many electronic devices are capable of wirelessly communicating with other electronic devices. Notably, these electronic devices can include a networking subsystem that implements a network interface for: a cellular network (UMTS, LTE, etc.), a wireless local area network (e.g., a wireless network such as described in the Institute of Electrical and Electronics Engineers (IEEE) 802.11 standard or Bluetooth™ from the Bluetooth Special Interest Group of Kirkland, Washington), and/or another type of wireless network. For example, many electronic devices communicate with each other via wireless local area networks (WLANs) using an IEEE 802.11-compatible communication protocol (which is sometimes collectively referred to as ‘Wi-Fi’). In a typical deployment, a Wi-Fi-based WLAN includes one or more access points (or basic service sets or BSSs) that may communicate wirelessly with each other and with other electronic devices using Wi-Fi, and that provide access to another network (such as the Internet) via IEEE 802.3 (which is sometimes referred to as ‘Ethernet’).

An access point in a WLAN typically advertises its existence by periodically broadcasting beacons or by providing probe responses that include an identifier of the WLAN, such as an SSID. For example, the SSID of an access point may include a name of the WLAN.

However, an access point broadcasting an SSID even when intended users are not within wireless range of the access point is often not useful and can result in security issues. Moreover, in hospitality deployments (such as a hotel or restaurants), broadcasting an SSID of a public free WLAN is often unnecessary when a billing system is unavailable or an authorization system is not operating.

In principle, these problems may be reduced using time-based scheduling, such when an access point as only broadcasting a particular SSID at certain times based on a predefined time-based schedule. However, in practice, time-based scheduling only offers limited flexibility and is typically not very useful in home or hospitality deployments. For example, a user may not be able to detect and join a WLAN at a different time than the broadcast times of an SSID of the WLAN in a predefined time-based schedule.

### SUMMARY

An access point that selectively provides an identifier of a WLAN is described. This access point may include an interface circuit that communicates with an electronic device and a second electronic device. During operation, the access point receives, associated with the electronic device, information specifying the second electronic device and optionally the identifier of the WLAN (such as a personalized WLAN). When the access point detects a presence of the second electronic device in proximity to the access point, the access point selectively provides the identifier of the WLAN.

Alternatively, when the access point does not detect the presence of the second electronic device in proximity to the access point within a time interval, the access point may selectively disable the identifier of the WLAN.

Note that the identifier of the WLAN may include an SSID of the WLAN. For example, the SSID may include a personalized SSID of a user of the second electronic device.

Moreover, the electronic device may include a controller of the access point or a second access point in a network that includes the access point.

Furthermore, proximity to the access point may include when the second electronic device is within wireless range of the access point.

Additionally, the access point may receive a packet or a frame associated with the second electronic device that includes the information (such as a probe request), and detecting the presence of the second electronic device may be based at least in part on the information. For example, the information may include an identifier of the second electronic device, such as a media access control (MAC) address of the second electronic device. Note that the WLAN may uses an IEEE 802.11-compatible communication protocol, and the packet or the frame may be communicated using a different communication protocol (such as a cellular-telephone communication protocol, Zigbee or Bluetooth) than the IEEE 802.11-compatible communication protocol.

In some embodiments, selectively providing the identifier of the WLAN may include broadcasting the identifier of the WLAN in a beacon. Alternatively or additionally, selectively providing the identifier of the WLAN may include providing, addressed to the second electronic device, the identifier of the WLAN. For example, the access point may provide a probe response addressed to the second electronic device with the identifier of the WLAN.

Moreover, the access point may selectively apply a policy to a second identifier of a second WLAN (such as one or more destined or corresponding profiled WLANs) based at least in part on whether the access point detects the presence of the second electronic device in proximity to the access point. For example, the policy may include selectively disabling providing of the second identifier of the second WLAN when the second electronic device (or another electronic device) is not present in proximity to the access point. Note that the WLAN may be associated with a user of the second electronic device, and the second WLAN may be associated with a different user than the user.

Furthermore, the access point may receive, associated with a computer, authentication information associated with the second electronic device, and the access point may detect the presence of the second electronic device in proximity to the access point based at least on the authentication information.

In some embodiments, instead of receiving the information specifying the second electronic device and the identifier of the WLAN, the electronic device may only receive the information specifying the second electronic device.

Another embodiment provides the controller that performs counterparts to at least of the aforementioned operations in one or more of the preceding embodiments.

Another embodiment provides the second access point that performs counterparts to at least of the aforementioned operations in one or more of the preceding embodiments.

Another embodiment provides the computer that performs counterparts to at least of the aforementioned operations in one or more of the preceding embodiments.

Another embodiment provides a computer-readable storage medium with program instructions for use with the access point, the controller, the second access point or the computer. When executed by the access point, the controller, the second access point or the computer, the program instructions cause the access point, the controller, the second access point or the computer to perform at least some of the aforementioned operations or counterparts to at least some of the aforementioned operations in one or more of the preceding embodiments.

Another embodiment provides a method, which may be performed by the access point, the controller, the second access point or the computer. This method includes at least some of the aforementioned operations or counterparts to at least some of the aforementioned operations in one or more of the preceding embodiments.

This Summary is provided for purposes of illustrating some exemplary embodiments, so as to provide a basic understanding of some aspects of the subject matter described herein. Accordingly, it will be appreciated that the above-described features are examples and should not be construed to narrow the scope or spirit of the subject matter described herein in any way. Other features, aspects, and advantages of the subject matter described herein will become apparent from the following Detailed Description, Figures, and Claims.

### BRIEF DESCRIPTION OF THE FIGURES

FIG. 1 is a block diagram illustrating an example of communication among electronic devices in accordance with an embodiment of the present disclosure.

FIG. 2 is a flow diagram illustrating an example of a method for selectively providing an identifier of a wireless local area network (WLAN) using an access point in FIG. 1 in accordance with an embodiment of the present disclosure.

FIG. 3 is a drawing illustrating an example of communication between an access point and optionally a controller, optionally a second access point or optionally a computer in FIG. 1 in accordance with an embodiment of the present disclosure.

FIG. 4 is a block diagram illustrating an example of an electronic device in accordance with an embodiment of the present disclosure.

Note that like reference numerals refer to corresponding parts throughout the drawings. Moreover, multiple instances of the same part are designated by a common prefix separated from an instance number by a dash.

### DETAILED DESCRIPTION

An access point that selectively provides an identifier of one or more WLANs (such as a WLAN) is described. This access point may include an interface circuit that communicates with an electronic device and a second electronic device (which refers to a specific electronic device). During operation, the access point may receive, associated with the electronic device, information specifying the second electronic device and optionally the identifier of the WLAN (such as a personalized WLAN). When the access point detects a presence of the second electronic device in proximity to the access point, the access point may selectively provide the identifier of the WLAN for the second electronic device. For example, the access point may provide an identifier of a personalized WLAN for the second electronic device. This may be the identifier of a profiled or personalized WLAN to which the electronic device or another electronic device (such as an Internet-of-things or IoT electronic device) may want to connect. Alternatively, when the access point does not detect the presence of the second electronic device in proximity to the access point within a time interval, the access point may selectively disable the identifier of the WLAN. Note that the identifier of the WLAN may include an SSID of the WLAN. For example, the SSID may include a personalized SSID of the second electronic device.

By selectively providing the identifier of the WLAN, these communication techniques may improve communication performance of the WLAN and security of the WLAN. For example, the communication techniques may reduce management frame overhead in the access point, such as beacons or probe responses. Moreover, the communication techniques may improve the flexibility of the WLAN by dynamically modifying whether the identifier of the WLAN is provided based at least in part on the detected presence of the second electronic device in proximity to the access point. Furthermore, the communication techniques may allow the identifier of the WLAN to be selectively provided based at least in part on whether a billing system is available or when an authorization system is operating. These capabilities may be useful in home, entertainment and hospitality applications. Consequently, the communication techniques may improve the user experience when using or managing the access point and/or the network that includes the access point.

In the discussion that follows, electronic devices or components in a system communicate packets in accordance with a wireless communication protocol, such as: a wireless communication protocol that is compatible with an IEEE 802.11 standard (which is sometimes referred to as WiFi®, from the Wi-Fi Alliance of Austin, Texas), Bluetooth or Bluetooth low energy (BLE), an IEEE 802.15.4 standard (which is sometimes referred to as Zigbee), a cellular-telephone network or data network communication protocol (such as a third generation or 3G communication protocol, a fourth generation or 4G communication protocol, e.g., Long Term Evolution or LTE (from the 3^{rd} Generation Partnership Project of Sophia Antipolis, Valbonne, France), LTE Advanced or LTE-A, a fifth generation or 5G communication protocol, or other present or future developed advanced cellular communication protocol), and/or another type of wireless interface (such as another wireless-local-area-network interface). For example, an IEEE 802.11 standard may include one or more of: IEEE 802.11a, IEEE 802.11b, IEEE 802.11g, IEEE 802.11-2007, IEEE 802.11n, IEEE 802.11-2012, IEEE 802.11-2016, IEEE 802.11ac, IEEE 802.11ax, IEEE 802.11ba, IEEE 802.11be, or other present or future developed IEEE 802.11 technologies. Moreover, an access point, a radio node, a base station or a switch in the wireless network may communicate with a local or remotely located computer (such as a controller) using a wired communication protocol, such as a wired communication protocol that is compatible with an IEEE 802.3 standard (which is sometimes referred to as ‘Ethernet’), e.g., an Ethernet II standard. However, a wide variety of communication protocols may be used in the system, including wired and/or wireless communication. In the discussion that follows, Wi-Fi and Ethernet are used as illustrative examples.

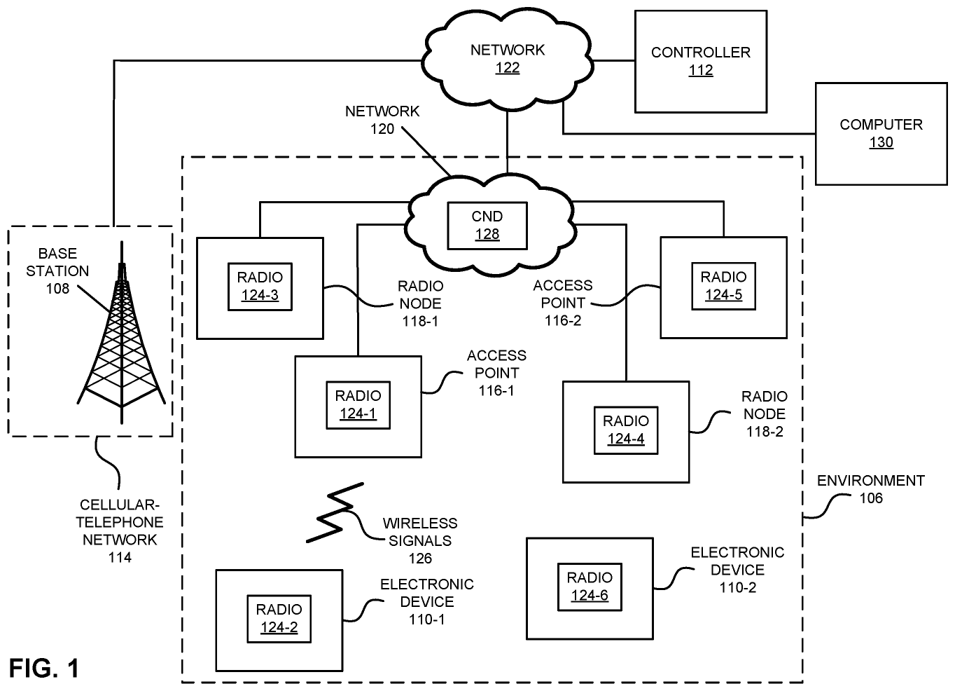

We now describe some embodiments of the communication techniques. FIG. 1 presents a block diagram illustrating an example of communication in an environment 106 with one or more electronic devices 110 (such as cellular telephones, portable electronic devices, stations or clients, another type of electronic device, etc., which are sometimes referred to as ‘end devices’) via a cellular-telephone network 114 (which may include a base station 108), one or more access points 116 (which may communicate using Wi-Fi) in a WLAN and/or one or more radio nodes 118 (which may communicate using LTE) in a small-scale network (such as a small cell). For example, the one or more radio nodes 118 may include: an Evolved Node B (eNodeB), a Universal Mobile Telecommunications System (UMTS) NodeB and radio network controller (RNC), a New Radio (NR) gNB or gNodeB (which communicates with a network with a cellular-telephone communication protocol that is other than LTE), etc. In the discussion that follows, an access point, a radio node or a base station are sometimes referred to generically as a ‘communication device.’ Moreover, one or more base stations (such as base station 108), access points 116, and/or radio nodes 118 may be included in one or more wireless networks, such as: a WLAN, a small cell, and/or a cellular-telephone network. In some embodiments, access points 116 may include a physical access point and/or a virtual access point that is implemented in software in an environment of an electronic device or a computer.

Note that access points 116 and/or radio nodes 118 may communicate with each other and/or controller 112 (which may be a local or a cloud-based controller that manages and/or configures access points 116, radio nodes 118 and/or a computer network device (CND) 128, or that provides cloud-based storage and/or analytical services) using a wired communication protocol (such as Ethernet) via network 120 and/or 122. However, in some embodiments, access points 116 and/or radio nodes 118 may communicate with each other and/or controller 112 using wireless communication (e.g., one of access points 116 may be a mesh access point in a mesh network). Note that networks 120 and 122 may be the same or different networks. For example, networks 120 and/or 122 may an LAN, an intra-net or the Internet. In some embodiments, network 120 may include one or more routers and/or switches (such as computer network device 128).

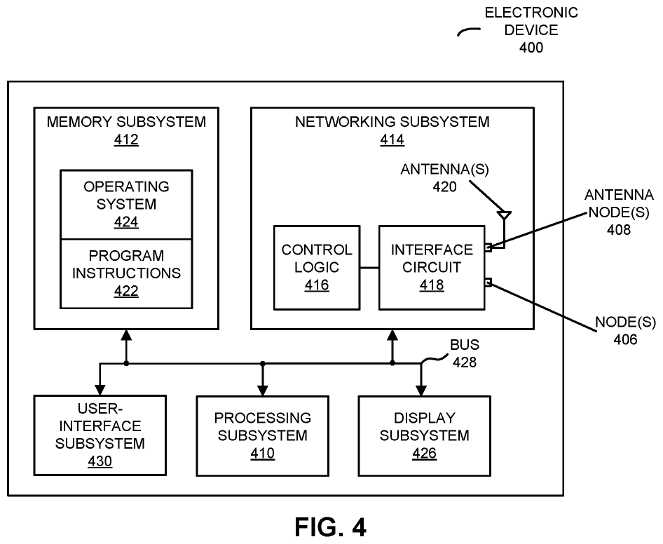

As described further below with reference to FIG. 4, electronic devices 110, controller 112, access points 116, radio nodes 118 and computer network device 128 may include subsystems, such as a networking subsystem, a memory subsystem and a processor subsystem. In addition, electronic devices 110, access points 116 and radio nodes 118 may include radios 124 in the networking subsystems. More generally, electronic devices 110, access points 116 and radio nodes 118 can include (or can be included within) any electronic devices with the networking subsystems that enable electronic devices 110, access points 116 and radio nodes 118 to wirelessly communicate with one or more other electronic devices. This wireless communication can comprise transmitting access on wireless channels to enable electronic devices to make initial contact with or detect each other, followed by exchanging subsequent data/management frames (such as connection requests and responses) to establish a connection, configure security options, transmit and receive frames or packets via the connection, etc.

During the communication in FIG. 1, access points 116 and/or radio nodes 118 and electronic devices 110 may wired or wirelessly communicate while: transmitting access requests and receiving access responses on wireless channels, detecting one another by scanning wireless channels, establishing connections (for example, by transmitting connection requests and receiving connection responses), and/or transmitting and receiving frames or packets (which may include information as payloads).

As can be seen in FIG. 1, wireless signals 126 (represented by a jagged line) may be transmitted by radios 124 in, e.g., access points 116 and/or radio nodes 118 and electronic devices 110. For example, radio 124-1 in access point 116-1 may transmit information (such as one or more packets or frames) using wireless signals 126. These wireless signals are received by radios 124 in one or more other electronic devices (such as radio 124-2 in electronic device 110-1). This may allow access point 116-1 to communicate information to other access points 116 and/or electronic device 110-1. Note that wireless signals 126 may convey one or more packets or frames.

In the described embodiments, processing a packet or a frame in access points 116 and/or radio nodes 118 and electronic devices 110 may include: receiving the wireless signals with the packet or the frame; decoding/extracting the packet or the frame from the received wireless signals to acquire the packet or the frame; and processing the packet or the frame to determine information contained in the payload of the packet or the frame.

Note that the wireless communication in FIG. 1 may be characterized by a variety of performance metrics, such as: a data rate for successful communication (which is sometimes referred to as ‘throughput’), an error rate (such as a retry or resend rate), a mean-squared error of equalized signals relative to an equalization target, intersymbol interference, multipath interference, a signal-to-noise ratio, a width of an eye pattern, a ratio of number of bytes successfully communicated during a time interval (such as 1-10 s) to an estimated maximum number of bytes that can be communicated in the time interval (the latter of which is sometimes referred to as the ‘capacity’ of a communication channel or link), and/or a ratio of an actual data rate to an estimated data rate (which is sometimes referred to as ‘utilization’). While instances of radios 124 are shown in components in FIG. 1, one or more of these instances may be different from the other instances of radios 124.

In some embodiments, wireless communication between components in FIG. 1 uses one or more bands of frequencies, such as: 900 MHz, 2.4 GHz, 5 GHz, 6 GHz, 7 GHz, 60 GHz, the Citizens Broadband Radio Spectrum or CBRS (e.g., a frequency band near 3.5 GHz), and/or a band of frequencies used by LTE or another cellular-telephone communication protocol or a data communication protocol. Note that the communication between electronic devices may use multi-user transmission (such as orthogonal frequency division multiple access or OFDMA).

Although we describe the network environment shown in FIG. 1 as an example, in alternative embodiments, different numbers or types of electronic devices may be present. For example, some embodiments comprise more or fewer electronic devices. As another example, in another embodiment, different electronic devices are transmitting and/or receiving packets or frames.

As discussed previously, periodically broadcasting beacons with an SSID of a WLAN or providing probe responses with the SSID of the WLAN is often unnecessary and may increase security risks to the WLAN. In order to address these problems, an access point (such as access point 116-1) may selectively provide an identifier of a WLAN.

Notably, controller 112 or a second access point (such as access point 116-2) may provide, to access point 116-1, information specifying one of electronic devices 110 (such as electronic device 110-1) and optionally the identifier of the WLAN (such as the SSID of the WLAN). For example, the SSID may include a personalized SSID of a user of electronic device 110-1.

Then, when access point 116-1 detects a presence of electronic device 110-1 in proximity to access point 116-1, access point 116-1 may selectively provide the identifier of the WLAN. Note that selectively providing the identifier of the WLAN may include broadcasting the identifier of the WLAN in a beacon. Alternatively or additionally, selectively providing the identifier of the WLAN may include providing, to electronic device 110-1, the identifier of the WLAN. For example, access point 116-1 may provide a probe response addressed to electronic device 110-1 with the identifier of the WLAN. Moreover, when access point 116-1 does not detect the presence of electronic device 110-1 in proximity to access point 116-1, access point 116-1 may selectively disable the identifier of the WLAN.

In some embodiments, access point 116-1 may detect a presence of electronic device 110-1 in proximity when electronic device 110-1 is within wireless range of access point 116-1. For example, access point 116-1 may receive a packet or a frame from electronic device 110-1 that includes the information (such as a probe request), and detecting the presence of electronic device 110-1 may be based at least in part on the information. Notably, the information may include an identifier of electronic device 110-1 (such as a MAC address of electronic device 110-1), and access point 116-1 may detect the presence of electronic device 110-1 by comparing the identifier of electronic device 110-1 with the previously received information specifying electronic device 110-1, which may include the identifier of electronic device 110-1. (Therefore, in some embodiments, electronic device 110-1 may disable a dynamic MAC address capability in order to enable use of the communication techniques.) Alternatively, the WLAN may use an IEEE 802.11-compatible communication protocol, and the packet or the frame may be communicated using a different communication protocol (such as a cellular-telephone communication protocol, Zigbee, Bluetooth or BLE) than the IEEE 802.11-compatible communication protocol. The packet or the frame communicated using the different communication protocol may include an identifier of electronic device 110-1, and access point 116-1 may detect the presence of electronic device 110-1 by comparing the identifier of electronic device 110-1 with the previously received information specifying electronic device 110-1, which may include the identifier of electronic device 110-1.

Moreover, in some embodiments, access point 116-1 may receive, from a computer 130 (such as a remote authentication dial-in user service or RADIUS server), authentication information associated with electronic device 110-1, and access point 116-1 may detect the presence of electronic device 110-1 in proximity to access point 116-1 based at least on the authentication information (e.g., by comparing the authentication information, which may specify electronic device 110-1, with the previously received information specifying electronic device 110-1).

Furthermore, access point 116-1 may selectively apply a policy to a second identifier of a second WLAN (such as a second SSID of the second WLAN) based at least in part on whether access point 116-1 detects the presence of electronic device 110-1 in proximity to access point 116-1. For example, access point 116-1 may selectively disable providing of the second identifier of the second WLAN when electronic device 110-1 is not present in proximity to access point 116-1. Note that the WLAN may be associated with the user of electronic device 110-1, and the second WLAN may be associated with a different user than the user.

In these ways, the communication techniques may improve security of the WLAN and may reduce management overhead of the WLAN, which may improve the communication performance of access point 116-1. Moreover, the selective providing of the identifier of the WLAN may allow access point 116-1 to dynamically respond to changing conditions, such as the presence or the absence of electronic device 110-1 in proximity to access point 116-1. Consequently, the communication techniques may improve the user experience when using or managing access point 116-1 and/or a network that includes access point 116-1.

While the preceding discussion illustrated the wireless detection of when electronic device 110-1 is proximate to access point 116-1, a wide variety of techniques may be used to detect when electronic device 110-1 is proximate to access point 116-1. For example, the presence of electronic device 110-1 (or a user of electronic device 110-1) may be detected optically, such as using a camera or an image sensor in or associated with access point 116-1 and an image-processing technique (such as a pretrained neural network, e.g., a convolutional neural network). Moreover, while the communication techniques illustrated the selective providing of the identifier of the WLAN based at least in part on the presence (or absence) of electronic device 110-1 in proximity to access point 116-1, in other embodiments the selective providing of the identifier of the WLAN may be based at least in part on one or more additional or different criteria, such as whether a billing system associated with the WLAN is available or when an authorization system associated with the WLAN is operating. More generally, the communication techniques may be used to selectively provide an identifier of another electronic device.

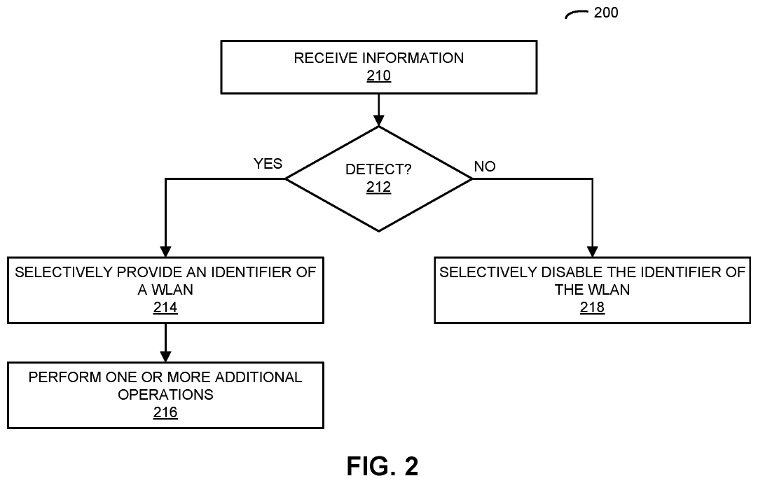

We now describe embodiments of the method. FIG. 2 presents a flow diagram illustrating an example of a method 200 for selectively providing an identifier of a WLAN, which may be performed by an access point (such as one of access points 116 or one of radio nodes 118 in FIG. 1). During operation, the access point may receive, associated with an electronic device, information (operation 210) specifying a second electronic device and optionally the identifier of the WLAN. Note that the identifier of the WLAN may include an SSID of the WLAN. For example, the SSID may include a personalized SSID of a user of the second electronic device.

When the access point detects (operation 212) a presence of the second electronic device in proximity to the access point, the access point may selectively provide the identifier of the WLAN (operation 214). For example, proximity to the access point may include when the second electronic device is within wireless range of the access point.

In some embodiments, the access point may optionally perform one or more additional operations (operation 216). For example, the access point may receive a packet or a frame associated with the second electronic device that includes the information (such as a probe request), and detecting the presence of the second electronic device may be based at least in part on the information. For example, the information may include an identifier of the second electronic device, such as a MAC address of the second electronic device. Note that the WLAN may uses an IEEE 802.11-compatible communication protocol, and the packet or the frame may be communicated using a different communication protocol (such as a cellular-telephone communication protocol, Zigbee, Bluetooth or BLE) than the IEEE 802.11-compatible communication protocol.

In some embodiments, selectively providing the identifier of the WLAN (operation 214) may include broadcasting the identifier of the WLAN in a beacon. Alternatively or additionally, selectively providing the identifier of the WLAN (operation 214) may include providing, addressed to the second electronic device, the identifier of the WLAN. For example, the access point may provide a probe response addressed to the second electronic device with the identifier of the WLAN.

Alternatively, when the access point does not detect (operation 212) the presence of the second electronic device in proximity to the access point in a time interval, the access point may selectively disable the identifier of the WLAN (operation 218).

Moreover, the electronic device may include a controller of the access point or a second access point in a network that includes the access point.

Furthermore, the access point may selectively apply a policy to a second identifier of a second WLAN based at least in part on whether the access point detects the presence of the second electronic device in proximity to the access point. For example, the policy may include selectively disabling providing of the second identifier of the second WLAN when the second electronic device is not present in proximity to the access point. Alternatively, when the second electronic device is detected, the access point may broadcast one or more profiled WLAN(s) where the second electronic device may connect or where another electronic device (such as an IoT electronic device) may connect. Note that the WLAN may be associated with a user of the second electronic device, and the second WLAN may be associated with a different user than the user.

Additionally, the access point may receive, associated with a computer, authentication information associated with the second electronic device, and the access point may detect the presence of the second electronic device in proximity to the access point based at least on the authentication information.

In some embodiments of method 200, there may be additional or fewer operations. For example, instead of receiving (operation 210) the information specifying the second electronic device and the identifier of the WLAN, the electronic device may only receive the information specifying the second electronic device. Furthermore, the order of the operations may be changed, and/or two or more operations may be combined into a single operation.

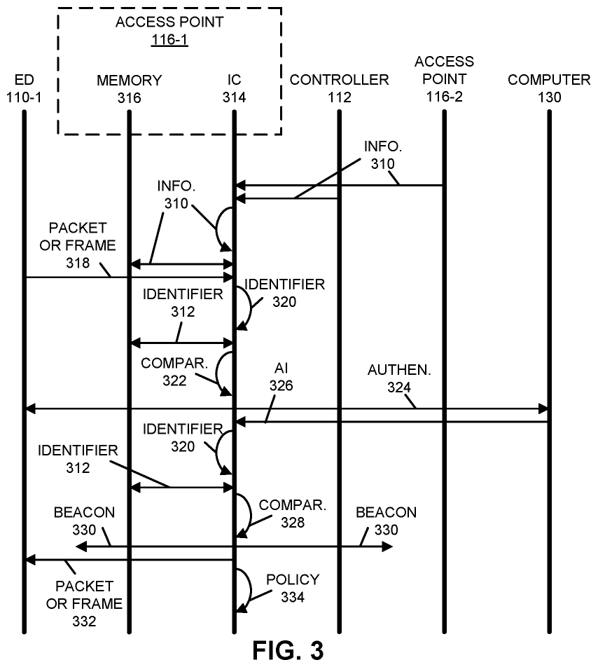

Embodiments of the communication techniques are further illustrated in FIG. 3, which presents a drawing illustrating an example of communication between access point 116-1 and optionally electronic device 110-1, optionally access point 116-2, optionally controller 112, and/or optionally computer 130. In FIG. 3, an interface circuit in access point 116-2 may provide, to access point 116-1, information 310 specifying electronic device 110-1 and optionally an identifier 312 of a WLAN. Alternatively, an interface circuit in controller 112 may provide, to access point 116-1, information 310 specifying electronic device 110-1 and identifier 312 of the WLAN.

After receiving information 310, an interface circuit 314 in access point 116-1 may extract information 310 and then store information 310 in memory 316 in access point 116-2. Subsequently, interface circuit 314 may detect a presence of electronic device 110-1 in proximity to access point 116-1. For example, electronic device (ED) 110-1 may provide a packet or frame 318 to access point 116-1, such as a probe request. When interface circuit 314 receives the packet or the frame 318, interface circuit 314 may extract information from the packet or the frame 318. This information may include an identifier 320 of electronic device 110-1 (such as a MAC address of electronic device 110-1), and interface circuit 314 may detect the presence of electronic device 110-1 in proximity to access point 116-1 by comparing 322 identifier 320 with identifier 312 stored in memory 316. More generally, the information in the packet or the frame 318 may include: a manufacturer of electronic device 110-1, a type of IEEE 802.11 used by electronic device 110-1, a data rate of electronic device 110-1, and optionally an operating system used by electronic device 110-1. This additional or different information may be used to detect the presence of electronic device 110-1 in proximity to access point 116-1.

Alternatively, electronic device 110-1 may be authenticated 324 by computer 130 (such as authenticating access of electronic device 110-1 to a network that includes access point 116-1). Then, computer 130 may provide authentication information (AI) 326 to access point 116-1 that indicates that electronic device 110-1 has been authenticated. After receiving authentication information 326, interface circuit 314 may determine that electronic device 110-1 is in proximity to access point 116-1 based on authentication information 326. For example, authentication information 326 may specify electronic device 110-1 (such as identifier 320), and interface circuit 314 may detect the presence of electronic device 110-1 in proximity to access point 116-1 by comparing 328 identifier 320 with identifier 312 stored in memory 316.

When interface circuit 314 detects the presence of electronic device 110-1 in proximity to access point 116-1, interface circuit 314 may selectively provide identifier 312 of the WLAN. For example, interface circuit 314 may provide a beacon 330 with identifier 312 of the WLAN. Alternatively or additionally, interface circuit 314 may provide a packet or a frame 332 (such as a probe response) to electronic device 110-1 with identifier 312 of the WLAN.

In some embodiments, interface circuit 314 may selectively apply a policy 334 to a second identifier of a second WLAN based at least in part on whether electronic device 110-1 is in proximity to access point 116-1. For example, interface circuit 314 may selectively disable providing of the second identifier of the second WLAN when electronic device 110-1 is not present in proximity to access point 116-1.

While FIG. 3 illustrates communication between components using unidirectional or bidirectional communication with lines having single arrows or double arrows, in general the communication in a given operation in this figure may involve unidirectional or bidirectional communication. Moreover, while FIG. 3 illustrates operations being performed sequentially or at different times, in other embodiments at least some of these operations may, at least in part, be performed concurrently or in parallel.

We now further describe the communication techniques. In a first use case, the communication techniques may be used in a personal network deployment. A user may have multiple SSIDs, such as for one or more Internet-of-things devices, one or more guest SSIDs and one or more personal SSIDs. When the user is not present in the wireless coverage area of the deployment, they may want to restrict the one or more personalized SSIDs (which may have full privileges) so that they are not broadcasted. However, the user may want to broadcast the subordinate SSIDs with some limitation. Consequently, when the user is not present in the wireless coverage area of the deployment, the one or more personalized SSIDs may not be visible and the associated WLAN(s) may not accept any wireless frames. This may reduce or eliminate a vulnerability to attacks. Moreover, the user may have direct control as to when a specific SSID is broadcast without much intervention (such as based at least in part whether the user is present in the wireless environment or not). These capabilities may allow a parental or policy-based control (such as children cannot watch television when a parent is not home) to be enforced on other SSIDs based at least in part on the presence (or absence) or an authorized electronic device associated with the user. Alternatively or additionally, the capabilities may allow a personalized network or WLAN to follow or migrate with a user, from one access point to another.

In a second use case, a restaurant providing the free public WLAN may want to keep the WLAN available only after the billing system and/or authorization system is operating. At other times, there may not be a need to keep the public WLAN available (such as if there is an operator error that attempts to leave the public WLAN active).

In a third use case, free public WLANs are increasingly available at a variety of locations. This infrastructure may use the communication techniques to provide personalized or customized WLANs as a service instead of just providing the same public WLAN to each user. For example, an elite user may register for a personalized WLAN service using public infrastructure (such as in an airport). When the public WLAN infrastructure (such as an access point) detects that a registered or authorized electronic device is in the vicinity or proximate, this public WLAN infrastructure may provide an identifier of a personalized or customized WLAN (such as a personalized SSID), which the registered user can latch on to. Otherwise, the personalized SSID may be hidden (e.g., the personalized SSID may be disabled if the elite user is not in proximity). Note that this capability may be provided as a service. In addition, note that this capability may reduce the likelihood of a security attack on the WLAN or an electronic device of the user.

In order to configure the communication techniques, a controller may provide a broadcast profile (with one or more MAC addresses of one or more electronic devices, and one or more associated SSIDs of one or more WLANs). An access point may detect the presence of one of the one or more electronic devices using the information in the broadcast profile. If the access point detects a profiled MAC address, the access point may start broadcasting one or more SSIDs that are mapped in the broadcast profile to the electronic device. Alternatively or additionally, the access point may apply one or more profiled to the one or more SSIDs. Moreover, the access point may periodically monitor or scan to see if the electronic device remains in the vicinity of the access point. If the access point determines that the electronic device is not present during a predefined amount of time (such as a time between 0.1-10 min), the access point may disable the associated one or more SSIDs.

For example, an access point may be configured with two SSIDs: a subordinated SSID that is available at all times; and a personalized master SSID that is only available when an electronic device having MAC address a1:b1:c1:d1:e1:f1 is present or in the vicinity. When the personalized master SSID is operational, both the electronic device having MAC address a1:b1:c1:d1:e1:f1 and other electronic devices (such as another electronic device having MAC address a2:b2:c2:d2:e2:f2 may be able to detect and associated with or latch to the personalized master SSID. However, when the authorized electronic device having MAC address a1:b1:e1:d1:e1:f1 moves away from the vicinity, no electronic device may be able to detect and associated with or latch to the personalized master SSID.

In some embodiments, the controller or another access point may be able to define a policy for an SSID of a WLAN provided or hosted by the access point. For example, the access point may support a command line interface (CLI) command that can be used to define the policy, such as to an enable an on demand SSID when an authorized MAC address is present. Notably, the CLI command may include: set ssid_broadcast <authorized-Mac> <OndemandSSID>. The controller or the other access point may push this policy to the access point by providing this CLI command to the access point.

We now describe embodiments of an electronic device, which may perform at least some of the operations in the communication techniques. FIG. 4 presents a block diagram illustrating an example of an electronic device 400 in accordance with some embodiments, such as one of: base station 108, one of electronic devices 110, controller 112, one of access points 116, one of radio nodes 118, computer network device 128 or computer 130. This electronic device includes processing subsystem 410, memory subsystem 412, and networking subsystem 414. Processing subsystem 410 includes one or more devices configured to perform computational operations. For example, processing subsystem 410 can include one or more microprocessors, graphics processing units (GPUs), ASICs, microcontrollers, programmable-logic devices, and/or one or more digital signal processors (DSPs).

Memory subsystem 412 includes one or more devices for storing data and/or instructions for processing subsystem 410 and networking subsystem 414. For example, memory subsystem 412 can include DRAM, static random access memory (SRAM), and/or other types of memory. In some embodiments, instructions for processing subsystem 410 in memory subsystem 412 include: one or more program modules or sets of instructions (such as program instructions 422 or operating system 424, such as Linux, UNIX, Windows Server, or another customized and proprietary operating system), which may be executed by processing subsystem 410. Note that the one or more computer programs, program modules or instructions may constitute a computer-program mechanism. Moreover, instructions in the various modules in memory subsystem 412 may be implemented in: a high-level procedural language, an object-oriented programming language, and/or in an assembly or machine language. Furthermore, the programming language may be compiled or interpreted, e.g., configurable or configured (which may be used interchangeably in this discussion), to be executed by processing subsystem 410.

In addition, memory subsystem 412 can include mechanisms for controlling access to the memory. In some embodiments, memory subsystem 412 includes a memory hierarchy that comprises one or more caches coupled to a memory in electronic device 400. In some of these embodiments, one or more of the caches is located in processing subsystem 410.

In some embodiments, memory subsystem 412 is coupled to one or more high-capacity mass-storage devices (not shown). For example, memory subsystem 412 can be coupled to a magnetic or optical drive, a solid-state drive, or another type of mass-storage device. In these embodiments, memory subsystem 412 can be used by electronic device 400 as fast-access storage for often-used data, while the mass-storage device is used to store less frequently used data.

Networking subsystem 414 includes one or more devices configured to couple to and communicate on a wired and/or wireless network (i.e., to perform network operations), including: control logic 416, an interface circuit 418 and one or more antennas 420 (or antenna elements). (While FIG. 4 includes one or more antennas 420, in some embodiments electronic device 400 includes one or more nodes, such as antenna nodes 408, e.g., a metal pad or a connector, which can be coupled to the one or more antennas 420, or nodes 406, which can be coupled to a wired or optical connection or link. Thus, electronic device 400 may or may not include the one or more antennas 420. Note that the one or more nodes 406 and/or antenna nodes 408 may constitute input(s) to and/or output(s) from electronic device 400.) For example, networking subsystem 414 can include a Bluetooth networking system, a cellular networking system (e.g., a 3G/4G/5G network such as UMTS, LTE, etc.), a universal serial bus (USB) networking system, a coaxial interface, a High-Definition Multimedia Interface (HDMI) interface, a networking system based on the standards described in IEEE 802.11 (e.g., a Wi-Fi® networking system), an Ethernet networking system, and/or another networking system.

Note that a transmit or receive antenna pattern (or antenna radiation pattern) of electronic device 400 may be adapted or changed using pattern shapers (such as directors or reflectors) and/or one or more antennas 420 (or antenna elements), which can be independently and selectively electrically coupled to ground to steer the transmit antenna pattern in different directions. Thus, if one or more antennas 420 include N antenna pattern shapers, the one or more antennas may have 2^{N} different antenna pattern configurations. More generally, a given antenna pattern may include amplitudes and/or phases of signals that specify a direction of the main or primary lobe of the given antenna pattern, as well as so-called ‘exclusion regions’ or ‘exclusion zones’ (which are sometimes referred to as ‘notches’ or ‘nulls’). Note that an exclusion zone of the given antenna pattern includes a low-intensity region of the given antenna pattern. While the intensity is not necessarily zero in the exclusion zone, it may be below a threshold, such as 3 dB or lower than the peak gain of the given antenna pattern. Thus, the given antenna pattern may include a local maximum (e.g., a primary beam) that directs gain in the direction of electronic device 400 that is of interest, and one or more local minima that reduce gain in the direction of other electronic devices that are not of interest. In this way, the given antenna pattern may be selected so that communication that is undesirable (such as with the other electronic devices) is avoided to reduce or eliminate adverse effects, such as interference or crosstalk.

Networking subsystem 414 includes processors, controllers, radios/antennas, sockets/plugs, and/or other devices used for coupling to, communicating on, and handling data and events for each supported networking system. Note that mechanisms used for coupling to, communicating on, and handling data and events on the network for each network system are sometimes collectively referred to as a ‘network interface’ for the network system. Moreover, in some embodiments a ‘network’ or a ‘connection’ between the electronic devices does not yet exist. Therefore, electronic device 400 may use the mechanisms in networking subsystem 414 for performing simple wireless communication between the electronic devices, e.g., transmitting advertising or beacon frames and/or scanning for advertising frames transmitted by other electronic devices as described previously.

Within electronic device 400, processing subsystem 410, memory subsystem 412, and networking subsystem 414 are coupled together using bus 428. Bus 428 may include an electrical, optical, and/or electro-optical connection that the subsystems can use to communicate commands and data among one another. Although only one bus 428 is shown for clarity, different embodiments can include a different number or configuration of electrical, optical, and/or electro-optical connections among the subsystems.

In some embodiments, electronic device 400 includes a display subsystem 426 for displaying information on a display, which may include a display driver and the display, such as a liquid-crystal display, a multi-touch touchscreen, etc.

Moreover, electronic device 400 may include a user-interface subsystem 430, such as: a mouse, a keyboard, a trackpad, a stylus, a voice-recognition interface, and/or another human-machine interface. In some embodiments, user-interface subsystem 430 may include or may interact with a touch-sensitive display in display subsystem 426.

Electronic device 400 can be (or can be included in) any electronic device with at least one network interface. For example, electronic device 400 can be (or can be included in): a desktop computer, a laptop computer, a subnotebook/netbook, a server, a tablet computer, a cloud-based computing system, a smartphone, a cellular telephone, a smartwatch, a wearable electronic device, a consumer-electronic device, a portable computing device, an access point, a transceiver, a router, a switch, communication equipment, an eNodeB, a controller, test equipment, and/or another electronic device.

Although specific components are used to describe electronic device 400, in alternative embodiments, different components and/or subsystems may be present in electronic device 400. For example, electronic device 400 may include one or more additional processing subsystems, memory subsystems, networking subsystems, and/or display subsystems. Additionally, one or more of the subsystems may not be present in electronic device 400. Moreover, in some embodiments, electronic device 400 may include one or more additional subsystems that are not shown in FIG. 4. Also, although separate subsystems are shown in FIG. 4, in some embodiments some or all of a given subsystem or component can be integrated into one or more of the other subsystems or component(s) in electronic device 400. For example, in some embodiments instructions 422 is included in operating system 424 and/or control logic 416 is included in interface circuit 418.

Moreover, the circuits and components in electronic device 400 may be implemented using any combination of analog and/or digital circuitry, including: bipolar, PMOS and/or NMOS gates or transistors. Furthermore, signals in these embodiments may include digital signals that have approximately discrete values and/or analog signals that have continuous values. Additionally, components and circuits may be single-ended or differential, and power supplies may be unipolar or bipolar.

An integrated circuit (which is sometimes referred to as a ‘communication circuit’) may implement some or all of the functionality of networking subsystem 414 and/or of electronic device 400. The integrated circuit may include hardware and/or software mechanisms that are used for transmitting wireless signals from electronic device 400 and receiving signals at electronic device 400 from other electronic devices. Aside from the mechanisms herein described, radios are generally known in the art and hence are not described in detail. In general, networking subsystem 414 and/or the integrated circuit can include any number of radios. Note that the radios in multiple-radio embodiments function in a similar way to the described single-radio embodiments.

In some embodiments, networking subsystem 414 and/or the integrated circuit include a configuration mechanism (such as one or more hardware and/or software mechanisms) that configures the radio(s) to transmit and/or receive on a given communication channel (e.g., a given carrier frequency). For example, in some embodiments, the configuration mechanism can be used to switch the radio from monitoring and/or transmitting on a given communication channel to monitoring and/or transmitting on a different communication channel. (Note that ‘monitoring’ as used herein comprises receiving signals from other electronic devices and possibly performing one or more processing operations on the received signals)

In some embodiments, an output of a process for designing the integrated circuit, or a portion of the integrated circuit, which includes one or more of the circuits described herein may be a computer-readable medium such as, for example, a magnetic tape or an optical or magnetic disk. The computer-readable medium may be encoded with data structures or other information describing circuitry that may be physically instantiated as the integrated circuit or the portion of the integrated circuit. Although various formats may be used for such encoding, these data structures are commonly written in: Caltech Intermediate Format (CIF), Calma GDS II Stream Format (GDSII) or Electronic Design Interchange Format (EDIF), OpenAccess (OA), or Open Artwork System Interchange Standard (OASIS). Those of skill in the art of integrated circuit design can develop such data structures from schematics of the type detailed above and the corresponding descriptions and encode the data structures on the computer-readable medium. Those of skill in the art of integrated circuit fabrication can use such encoded data to fabricate integrated circuits that include one or more of the circuits described herein.

While the preceding discussion used Wi-Fi and/or Ethernet communication protocols as illustrative examples, in other embodiments a wide variety of communication protocols and, more generally, communication techniques may be used. Thus, the communication techniques may be used in a variety of network interfaces. Furthermore, while some of the operations in the preceding embodiments were implemented in hardware or software, in general the operations in the preceding embodiments can be implemented in a wide variety of configurations and architectures. Therefore, some or all of the operations in the preceding embodiments may be performed in hardware, in software or both. For example, at least some of the operations in the communication techniques may be implemented using program instructions 422, operating system 424 (such as a driver for interface circuit 418) or in firmware in interface circuit 418. Alternatively or additionally, at least some of the operations in the communication techniques may be implemented in a physical layer, such as hardware in interface circuit 418.

Note that the use of the phrases ‘capable of,’ ‘capable to,’ ‘operable to,’ or ‘configured to’ in one or more embodiments, refers to some apparatus, logic, hardware, and/or element designed in such a way to enable use of the apparatus, logic, hardware, and/or element in a specified manner.

While examples of numerical values are provided in the preceding discussion, in other embodiments different numerical values are used. Consequently, the numerical values provided are not intended to be limiting.

In the preceding description, we refer to ‘some embodiments.’ Note that ‘some embodiments’ describes a subset of all of the possible embodiments, but does not always specify the same subset of embodiments.

The foregoing description is intended to enable any person skilled in the art to make and use the disclosure, and is provided in the context of a particular application and its requirements. Moreover, the foregoing descriptions of embodiments of the present disclosure have been presented for purposes of illustration and description only. They are not intended to be exhaustive or to limit the present disclosure to the forms disclosed. Accordingly, many modifications and variations will be apparent to practitioners skilled in the art, and the general principles defined herein may be applied to other embodiments and applications without departing from the spirit and scope of the present disclosure. Additionally, the discussion of the preceding embodiments is not intended to limit the present disclosure. Thus, the present disclosure is not intended to be limited to the embodiments shown, but is to be accorded the widest scope consistent with the principles and features disclosed herein.

What is claimed is:

1. An access point, comprising:
an interface circuit configured to communicate with an electronic device and a second electronic device, wherein the access point is configured to perform operations comprising:
receiving, associated with the electronic device, information specifying the second electronic device, or the second electronic device and an identifier of a wireless local area network (WLAN); and
when the access point detects a presence of the second electronic device in proximity to the access point, selectively providing the identifier of the WLAN.

2. The access point of claim 1, wherein, when the access point does not detect the presence of the second electronic device in proximity to the access point within a time interval, the operations comprise selectively disabling the identifier of the WLAN.

3. The access point of claim 1, wherein the identifier of the WLAN comprises a selective service set identifier (SSID) of the WLAN.

4. The access point of claim 3, wherein the SSID comprises a personalized SSID of a user of the second electronic device.

5. The access point of claim 1, wherein the electronic device comprises a controller of the access point or a second access point in a network that comprises the access point.

6. The access point of claim 1, wherein proximity to the access point comprises when the second electronic device is within wireless range of the access point.

7. The access point of claim 1, wherein the operations comprise receiving, associated with the second electronic device, a packet or a frame;
wherein the packet or the frame comprises information; and
wherein detecting the presence of the second electronic device is based at least in part on the information.

8. The access point of claim 7, wherein the packet or the frame comprises a probe request.

9. The access point of claim 7, wherein the information comprises an identifier of the second electronic device.

10. The access point of claim 7, wherein the WLAN uses an Institute of Electrical and Electronics Engineers (IEEE) 802.11-compatible communication protocol, and the packet or the frame is communicated using a different communication protocol than the IEEE 802.11-compatible communication protocol.

11. The access point of claim 1, wherein the selective providing of the identifier of the WLAN comprises broadcasting the identifier of the WLAN in a beacon.

12. The access point of claim 1, wherein the selective providing of the identifier of the WLAN comprises providing, addressed to the second electronic device, the identifier of the WLAN.

13. The access point of claim 12, wherein the providing of the identifier of the WLAN comprises providing a probe response, addressed to the second electronic device, with the identifier of the WLAN.

14. The access point of claim 1, wherein the operations comprise selectively applying a policy to a second identifier of a second WLAN based at least in part on whether the access point detects the presence of the second electronic device in proximity to the access point.

15. The access point of claim 14, wherein the policy comprises selectively disabling providing of the second identifier of the second WLAN when the second electronic device is not present in proximity to the access point.

16. The access point of claim 14, wherein the WLAN is associated with a user of the second electronic device, and the second WLAN is associated with a different user than the user.

17. The access point of claim 1, wherein the operations comprise receiving, associated with a computer, authentication information associated with the second electronic device; and
wherein the access point detects the presence of the second electronic device in proximity to the access point based at least on the authentication information.

18. A non-transitory computer-readable storage medium for use in conjunction with an access point, the computer-readable storage medium storing program instructions that, when executed by the access point, cause the access point to perform operations comprising:
receiving, associated with an electronic device, information specifying a second electronic device and an identifier of a wireless local area network (WLAN); and
when the access point detects a presence of the second electronic device in proximity to the access point, selectively providing the identifier of the WLAN.

19. A method for selectively providing an identifier of a wireless local area network (WLAN), comprising:
by an access point:
receiving, associated with an electronic device, information specifying a second electronic device and the identifier of the WLAN; and
when the access point detects a presence of the second electronic device in proximity to the access point, selectively providing the identifier of the WLAN.

20. The method of claim 19, wherein the identifier of the WLAN comprises a selective service set identifier (SSID) of the WLAN.
